(19) United States
(12) Patent Application Publication
(10) Pub. No.: US 2018/0122247 A1
(43) Pub. Date: May 3, 2018

(54) INTEGRATED SYSTEM TO DETERMINE TURBULENT EFFECTS, IN PARTICULAR IN AIRCRAFTS IN FLIGHT

(71) Applicant: EVOLVE THE FUTURE SRL, Cesenatico (FC) (IT)

(72) Inventor: Gaetano Rizzi, Busto Arsizio (VA) (IT)

(21) Appl. No.: 15/565,551

(22) PCT Filed: Apr. 29, 2016
(86) PCT No.: PCT/IB2016/052427

§ 371 Date: Oct. 10, 2017

(30) Foreign Application Priority Data
Apr. 30, 2015 (IT) 102015000013624

(51) Int. Cl. G08G 5/00; G01W 1/10

(52) U.S. Cl. CPC G08G 5/0091; G01W 2001/003; G01W 1/10

(57) ABSTRACT

A method for processing and providing information relating to the effects of turbulent movements present in a fluid and perceived or perceivable by a moving vehicle when acted on by these turbulent movements comprises the steps of detecting on-board a first moving vehicle A a perceived level of turbulence TpA to which the vehicle is subject in that moment; calculating a parameter N indicative of the turbulence by applying to the perceived level of turbulence TpA a correction function f(TpA, k1A, k2A, k3A, . . . knA) where k1A, k2A, k3A, . . . , knA are parameters considered to be indicative of the influence of the specific first moving vehicle A on the level of turbulence perceived in it; transmitting a pair of values formed by the parameter N and the position P of the first moving vehicle A at the moment when it is subject to the turbulence level TpA, so that they are received by a second moving vehicle B; calculating on-board the second moving vehicle B a predicted level of turbulence TpB by means of an inverse function f−1(N, k1B, k2B, k3B, . . . , knB), where k1B, k2B, k3B, . . . , knB are parameters considered to be indicative of the influence of the specific second moving vehicle B on the level of turbulence perceivable therein based on the parameter N; using the predicted level of turbulence TpB as an indication of the level of turbulence which would be perceived on the second moving vehicle B if it were to pass through said point P. Devices (11, 14) and electronic systems (10) applying this method are also described.

According to its more general aspect, the present invention relates to a system and to a method for processing information relating to the effects of turbulent movements present in a fluid and perceived or perceivable by a vehicle moving in this fluid when acted on by said turbulent movements. The moving vehicle may be of various types, for example aircraft or sea craft and the fluid consequently may be air or water.

In particular, in a preferred embodiment of the invention, the fluid is air and the object is an aircraft in flight. Below, however, it be clear how the invention may be applied also to other vehicles and fluids, such as navigating vessels. The sequence of turbulent movements to which the moving vehicle is exposed will be referred to here in short as “turbulence”.

In the case of aircraft, the definition of turbulence provided by the ICAO (International Civil Aviation Organization) is: “Series of jolts to which an aircraft in flight is subject when it encounters ascending or descending currents or gusts of wind”

On a worldwide level there exists a classification or official ICAO scale of turbulence which, however, is based empirically on the reactions of the aircraft as perceived by the persons on-board, namely:
light turbulence: momentary or slight variations in attitude and height of the aircraft;
moderate turbulence: more intense variations, but with aircraft under control;
severe turbulence: extensive and sudden variations, with aircraft momentarily out of control;
extreme turbulence: aircraft subject to violent shaking and totally out of control, with possible damage to the aircraft structure.

The measurement of the degree of turbulence is therefore based in the sensations of those on-board, these sensations however also depending on the type and state of the aircraft, the reaction of the pilot who, during a turbulent event, operates the steering instruments, the sitting position, the previous experiences of turbulence, etc. There is, therefore, no absolute measurement of turbulence.

The information supplied by the crew of an aircraft which has passed through a zone of turbulence is generally transmitted to other aircraft which are expected to pass through the same airspace shortly, but this information is usually not useful for determining beforehand the true nature of the turbulence which will be encountered once the zone is reached, both because of the subjective nature of the information supplied and because it relates to a different aircraft.

Moreover, an expert pilot may predict at a certain distance the presence of turbulence due to particular visible weather conditions (for example extensive cumuliform clouds of the cumulonimbus and/or cumulus type). However, there also exists so-called “clear air” turbulence, i.e. turbulence which is not indicated by air conditions visible at a distance.

It would therefore be useful to have an objective and prior indication of the turbulence which may be encountered along the travel route, both so as to able, for example, to alert the passengers and if necessary indicate to them the need to fasten the seat belts and to decide whether or not it is advisable to change route in order to avoid the turbulent zone.

Not knowing the real extent of the turbulence which will be directly encountered, it is however often difficult for the pilot to decide whether to change route, because such a change in route generally results in an increased fuel consumption.

The pilot should therefore first of all be able to assess whether the turbulence encountered if he remained on the same route would be sufficiently high to justify the increase in fuel consumption resulting from a change of route in order to avoid said turbulence.

Moreover, the choice from among different routes could also be influenced by the greater or lesser probability of passing in any case through new zones of turbulence and by the degree of any turbulence in these zones.

In fact, it could be that the pilot does not merely have to choice between a route which passes through a turbulent zone and a route without turbulent zones, but must instead choose between routes with different degrees of turbulence.

In this second case it would therefore be necessary to know in advance exactly the degree of turbulence encountered if the possible new routes were followed, in order to avoid, for example, situations where the difference between the turbulence avoided by a change of route and the turbulence encountered along the new route is minimal, making the increased fuel consumption resulting from a change of route again unjustifiable.

In the prior art, devices have been proposed for detecting remotely the presence of turbulent zones, so as to provide a prior instrumental indication to the specific aircraft equipped with these devices. However, these devices (such as so-called on-board weather radars) may detect only some types of turbulence and not others and provide only approximate information.

In particular, no known device is able for example to provide a reliable indication of turbulence in clear air (generally known as CAT, i.e. Clear Air Turbulence). This type of turbulence occurs mainly at altitude (for example at a height of about 6000 m) and nearly always in air where there are no clouds which could provide an indication of its presence.

Said turbulence is essentially due to a so-called “jet stream”, namely an intense stream at altitude concentrated along a near-horizontal axis, characterized by a high wind gradient or, in tropopause, by troughs and depressions, or is also caused by so-called mountain waves.

This phenomenon is at present not effectively signalled by any device and there exist only approximate indications provided by specialized information sources in world weather forecast bulletins, based mainly on very approximate mathematical models and conditioned by certain specific objective data which is very limited in both temporal and spatial terms. However, even when there are instruments which detect the degree of turbulence, the values detected may in reality be referred only to the specific aircraft which detected them. For the other aircraft the indications are only approximate and are not sufficient to allow careful decisions to be taken as regards for example the opportuneness of changing a route depending on the increased fuel consumption.

For example, US2011/0257818 describes a system which envisages portable devices which are located on-board aircraft and detect accelerations representing the degree of turbulence to which each aircraft is subject at that moment. The values detected may be used to determine whether the aircraft must undergo maintenance once it has landed. Moreover, the data of the various devices may be sent to a remote processing system which uses it to create a map of the turbulence zones which is then made available to all the aircraft. The indications as to turbulence relate, however, to the single aircraft which detected them and are of limited usefulness generally, except for providing an approximate indication as to the presence of turbulence.

WO2014/111842 describes instead a network for detecting the environmental conditions in the region of generic fixed or mobile stations (for example, including aircraft), in order to transmit the associated information to a land station which performs processing thereof and, based on said information, creates maps of the environmental conditions in a wider zone. These maps may then be transmitted to the fixed or mobile stations. This allows, for example, aircraft without weather radars to receive on-board synthetic images which simulate the images could be obtained on-board if a weather radar was in reality present, or also to amplify in a virtual manner the range of a real weather radar present on-board by supplementing the images supplied by this radar with the synthetic images processed and transmitted by the land stations. This does not solve, however, the problem of providing information which is suitable for each specific aircraft so as to have a reliable advance quantification of the degree of turbulence to which it will be subject.

US 2002/0039072 also describes a system which, based on the data sent by various aircraft to a land station, calculates in the land station the maps of the weather conditions which are then sent from the land station to the aircraft.

U.S. Pat. No. 8,344,933, U.S. Pat. No. 7,633,428 and US 2007/236366 describe systems for transferring the data detected by radars (in particular, by weather radars) between aircraft or between aircraft and land stations, again with the aim of obtaining a virtual extension of the range of the radars or replacing radars if not present on-board.

A general object of the present invention is to provide a method and a system which can be used to predict with a satisfactory degree of precision the effects of turbulence on a specific moving vehicle, in particular an aircraft in flight, before it enters into the turbulence zone.

In view of this object the idea which has occurred is to provide, according to the invention, a method for processing and providing information relating to the effects of turbulent movements present in a fluid and perceived or perceivable by a moving vehicle when acted on by these turbulent movements, comprising the steps of detecting on-board a first moving vehicle A a perceived level of turbulence Tp_{A} to which the vehicle is subject in that moment; calculating a parameter N indicative of the turbulence by applying to the perceived level of turbulence Tp_{A} a correction function f(Tp_{A}, k1_{A}, k2_{A}, k3_{A}, . . . , kn_{A}) where k1_{A}, k2_{A}, k3_{A}, . . . , kn_{A} are parameters considered to be indicative of the influence of the specific first moving vehicle A on the level of turbulence perceived in it; transmitting a pair of values formed by the parameter N and the position P of the first moving vehicle A at the moment when it is subject to the turbulence level Tp_{A}, so that they are received by a second moving vehicle B; calculating on-board the second moving vehicle B a predicted level of turbulence Tp_{B} by means of an inverse function f⁻¹(N, k1_{B}, k2_{B}, k3_{B}, . . . , kn_{B}), where k1_{B}, k2_{B}, k3_{B}, . . . , kn_{B} are parameters considered to be indicative of the influence of the specific second moving vehicle B on the level of turbulence perceivable therein based on the parameter N; using the predicted level of turbulence Tp_{B} as an indication of the level of turbulence which would be perceived on the second moving vehicle B if it were to pass through said point P.

Advantageously the first moving vehicles A consist of a plurality so as to provide a corresponding plurality of pairs of values N, P which define a map, in the fluid, of parameters N associated with the positions P of the moving vehicles of the plurality. In particular, the moving vehicles are advantageously aircraft.

Still in accordance with the invention, the idea which has occurred is to provide a system for processing and supplying information regarding the effects of turbulent movements present in a fluid and perceived or perceivable by a moving vehicle when acted on by these turbulent movements, the system using the method mentioned and being characterized in that it comprises an electronic detection device located on the first moving vehicle A and comprising acceleration sensors for detecting a perceived level of turbulence Tp_{A}, a processing unit intended to calculate the parameter N, an electronic memory intended to contain the parameters k1_{A}, k2_{A}, k3_{A}, . . . , kn_{A}, a GPS receiver (or other method suitable for determining position, height and speed) intended to detect the position P, and a transmitter for communicating remotely the pair of values N, P.

Advantageously the system also comprises an electronic signalling device located on the second moving vehicle B for receiving the pair of values N, P, the calculation of the predicted level of turbulence Tp_{B} and displaying thereof.

In particular, it has been found to be advantageous for the system to comprise integrated electronic devices which comprise both the electronic detection device and the electronic signalling device and which are intended to be located on-board both the first moving vehicle A and the second moving vehicle B.

These and other characteristic features of the invention will become clear from the description below.

In particular, in order to illustrate more clearly the innovative principles of the present invention and its advantages compared to the prior art, possible examples of embodiment applying these principles will be described below with the aid of the accompanying drawings. In the drawings:

FIG. 1 shows a schematic view of a system provided in accordance with the principles of the invention;

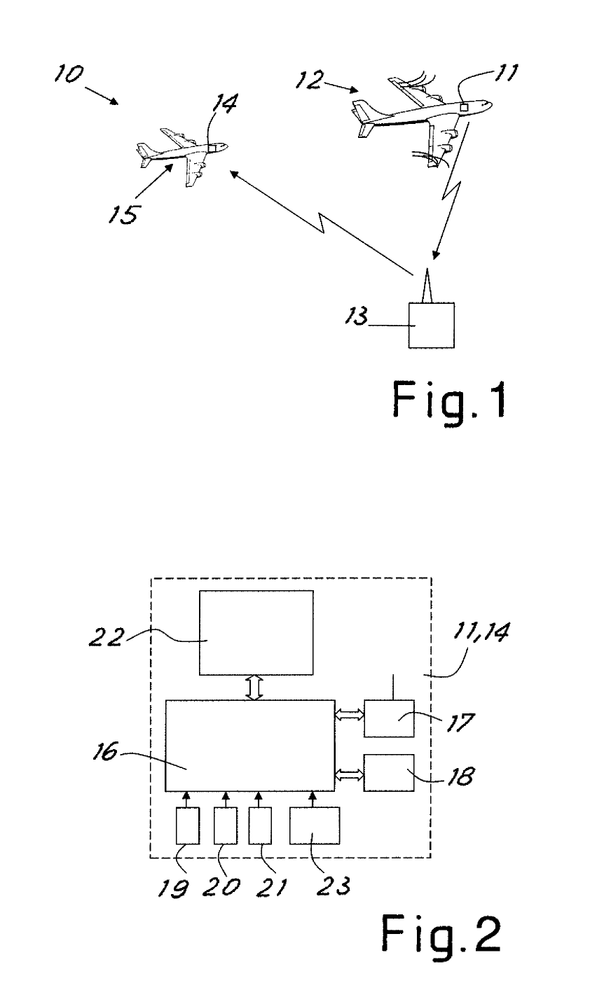

FIG. 2 shows a block diagram of an electronic device according to the invention;

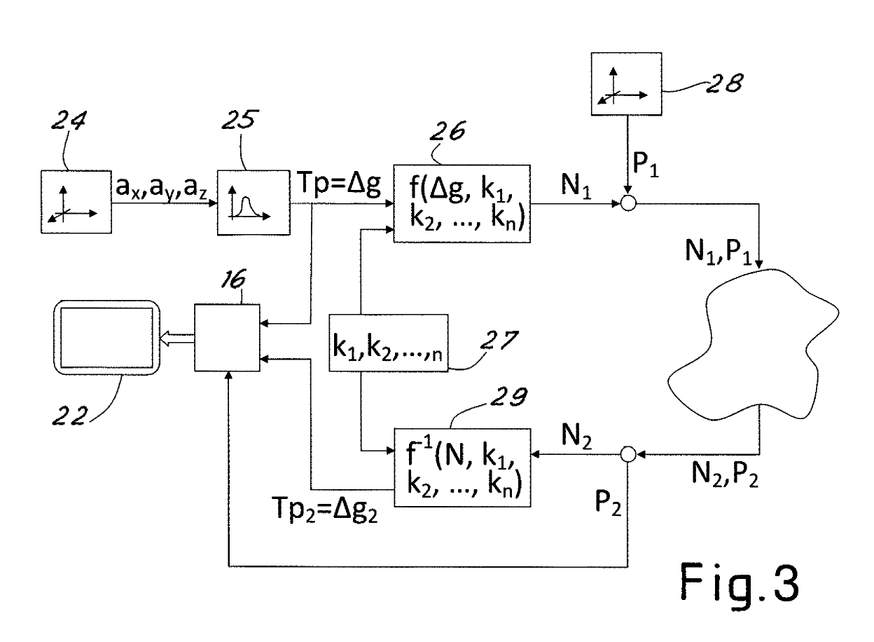

FIG. 3 shows a block diagram of operation of a device according to the invention;

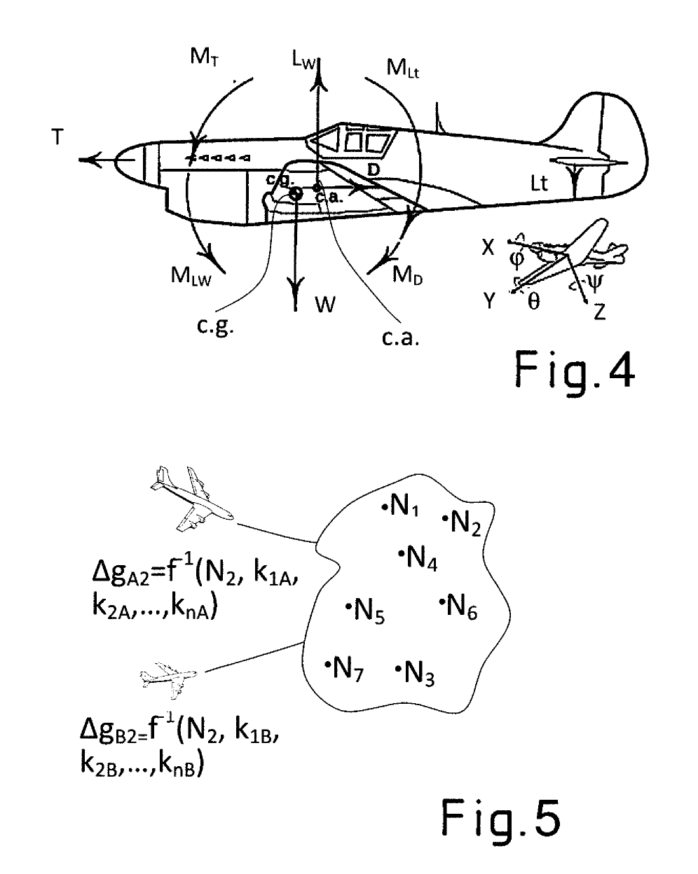

FIG. 4 shows in schematic form a possible reference system for the turbulence detected on an aircraft;

FIG. 5 illustrates in schematic form operation of the system according to the invention;

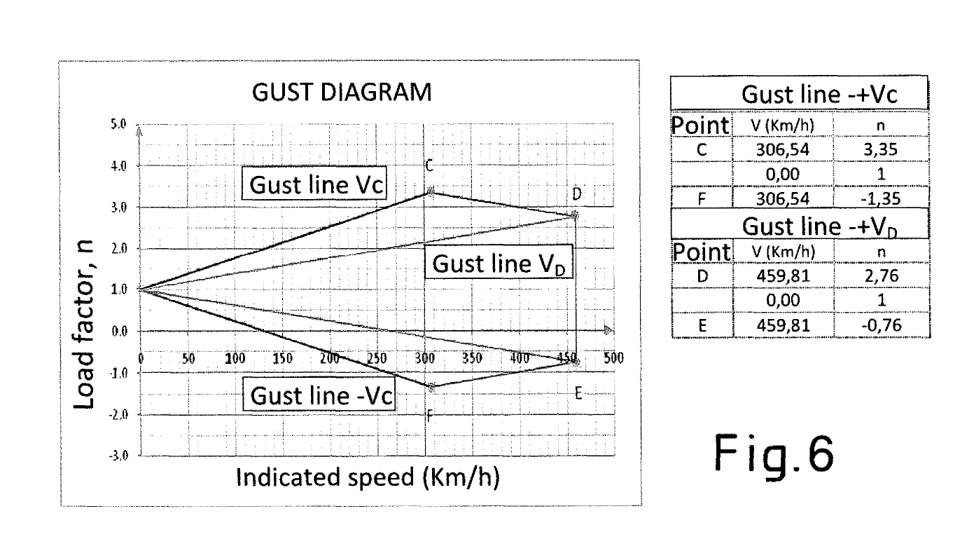

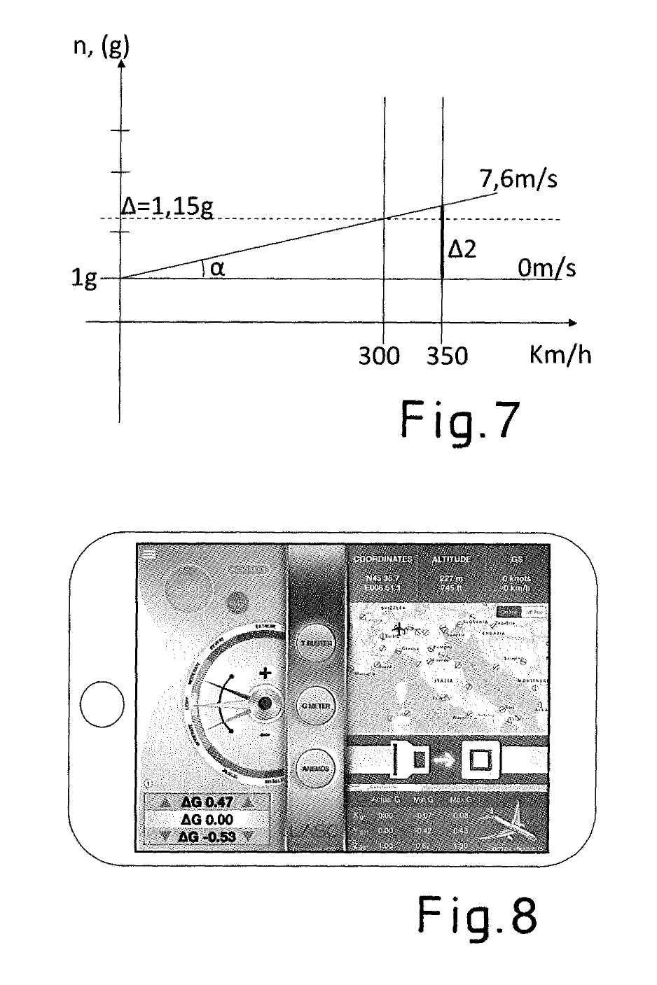

FIGS. 6 and 7 are gust diagrams for calculating an example according to the invention;

FIG. 8 shows possible displaying of the results of the processing operations on a screen of a device according to the invention.

With reference to the figures, FIG. 1 shows in schematic form a system realized in accordance with the invention. This system, which is generically indicated by 10, comprises an electronic detection device, indicated by 11, intended to be placed on-board a moving vehicle which may be subject to turbulent movements of the fluid in which it is at least partially immersed (for example in the case of a watercraft).

In particular, the moving vehicle may be advantageously an aircraft 12 and the fluid is in this case air. Below, for the sake of simplicity, reference will be made to this specific case, but it is understood that the vehicle subject to turbulent movements may be different, for example a watercraft and the fluid may be in this case, water, air or a combination of the two.

The detection device 11 may communicate with one or more remote stations 13 (for example an earth or satellite station) which in turn may communicate with an electronic signalling device 14 intended to be placed on-board another object which may be subject to turbulent movements of the fluid in which it is at least partially immersed, for example an aircraft in air.

For the sake of simplicity reference will be made to a single remote station 13, but it is understood that this station 13 could also be composed of a plurality of remote stations which are interconnected by a suitable communication system, so as to form basically a station 13 spread out so as to ensure greater range and coverage and/or provide the system with a greater immunity to faults.

The detection device 11 comprises sensors designed to detect the accelerations imparted to the aircraft 12 as a result of the turbulence. This device may be a portable device or may be integrated in the on-board instrumentation of the aircraft.

Advantageously, the device 11 or 14 may be a tablet which is suitably programmed or another suitable mobile device provided with an input/output interface (for example preferably a display screen of the touchscreen type), a suitable processing unit, a memory, transmission means and suitable sensors.

The transmission means may be wireless transmission means of the long-range type, so as to be able to reach autonomously earth or satellite stations, or may be of the short-range type (such as WiFi transmission means) which communicate wirelessly with on-board transceiver systems which in turn act as a bridge system for communicating with the earth or satellite stations.

For example, the device 11, 14 may be interfaced with any known digital data satellite transmission system which automatically sends the transmitted data (preferably suitably encrypted) of the device to a dedicated server which forms or forms part of the station 13 and which may be positioned both on land and on a satellite.

This dedicated server (which may be called a “Master Control Server”) retransmits the turbulence information, if necessary after suitable processing, to other aircraft equipped with a similar satellite system for data transmission and reception. The communication system may be preferably equipped with a back-up in a remote cloud centre for security and reliability reasons. The digital data transmission system may be advantageously chosen from among already existing systems so as to be immediately utilizable by the existing aircraft.

The communication system may preferably use a known dynamic mesh network topology, where the nodes of the network are the single objects located in the fluid, for example the aircraft. The nodes act as repeaters for transmitting the signal broadcast by the closest nodes to the equivalent nodes which are too distant to be reached directly. In this way it is possible to obtain a network capable of covering large distances, especially in rough or in any case “difficult” terrain, such as air space.

The sensors of the detection device 11 may be advantageously triaxial acceleration sensors, triaxial gyroscopes, or a combination of the two, with a sufficient detection precision for the turbulence values which are to be detected. For example, for the practical purposes of detecting turbulence in normal commercial aircraft, the scale of accelerations may be from −4 g to 4 g with a resolution of 1/10 of g, where g is the gravitational acceleration at the height of the event.

The device 11 or 14, in particular in the case of a portable device, may be advantageously provided with GPS (or other suitable system) for obtaining internal position and, preferably also speed, information.

Advantageously, as will be further clarified below, it is also possible to provide an integrated electronic device which comprises both the devices 11 and 14 so as to carry out both their functions.

FIG. 2 shows an example of a device 11 and/or 14, comprising a processing unit 16, wireless transceiver means 17, a memory 18, triaxial acceleration sensors 19, gyroscopic sensors (advantageously of the laser type) 20, a GPS receiver 21, a display 22 (advantageously of the touchscreen type) and optionally a suitable electric power supply battery 23 for portable use of the device. Such a device is known per se as regards all its hardware parts and therefore may be easily imagined by the person skilled in the art. It will therefore not be further described nor illustrated in detail.

In a preferred embodiment, the device 11 or 14 may be a tablet or a smartphone which comprises the components listed above supplied as a standard feature and is suitably programmed as will be clarified below. In particular, a suitably programmed IPhone or IPad made by the company Apple has been found to be suitable.

The device 11 measures the objective effect of the turbulence on the aircraft and may provide for example immediate feedback by means of the graphical and/or acoustic representation of the net acceleration perceived by its sensors. This may be useful for example for the pilot. Moreover, by storing the detected values it is possible to determine whether there is the need for maintenance of the aircraft once it has returned to ground.

The signalling device 14 is intended to show turbulence information which is associated with position data of said turbulence and which is transmitted to it by the remote station 13. The signalling device 14 may be a device different from the detection device 11 or may be the same as or similar to the device 11 so that the detection device and the signalling device are combined in a single apparatus. The functions of the signalling device may for example also be entered in a suitable tablet or smartphone which has been suitably programmed, as will be clear to the person skilled in the art on the basis of the description provided here.

The detection device 11 may calculate a numerical turbulence value and send it to the station 13 which may forward it, after reprocessing if necessary, to the signalling device 14 which may show on its display a turbulence value or a turbulence value map.

Although, for the sake of simplicity, reference is made in FIG. 1 and in the description to a first aircraft 12 subject to turbulence and a second aircraft 15 which could reach later the zone of said turbulence, in reality the system may envisage any number of aircraft in flight, each of which sends to the remote station(s) 13 the turbulence data which it detects and which receives from the remote station(s) 13 turbulence information or maps, as will be clarified below.

Essentially, with reference to the block diagram shown in FIG. 3, the device 1 detects the turbulence as an acceleration effect perceived inside the aircraft owing to the turbulence being passed through. Detection is performed by the acceleration sensors along three axes which produce acceleration values aₓ, a_{y}, a_{z} (block 24).

Since the turbulence has, as is known, a very particular progression in terms of frequency and direction of the acceleration components, it is also possible to perform digital filtering (block 25) of the acceleration measurements along the three axes of the sensors of the device, so as to filter movements of the device 11 which do not depend on said turbulence. This enables for example the measurement of the turbulence not to be affected by movements of the device 11 when it is of a portable nature. Filtering may be performed by means of a suitable software module of the sensor management program, as may be easily imagined by the person skilled in the art. Moreover, especially in the case of a portable device, the measurements of the sensors along the three axes of the device must be reoriented with respect to the spatial orientation of the device and the spatial orientation of the aircraft, so as to obtain turbulence values in the correct reference space, for example of the Cartesian type, for example the xy plane of the aircraft.

The value or vector of the perceived effect Tp of the turbulence detected by the device 11 may be advantageously obtained by means of determination of the maximum components of the intensity of the specific on-board acceleration associated with the turbulence wave, measured for the whole duration of the event.

Once the value of the turbulence Tp perceived on the aircraft (which may also be regarded as a variation of acceleration Δg) has been obtained, with the correct orientation, this value is processed (block 26) so as to provide a parameter N₁ which is not dependent on the specific parameters of the particular aircraft on which the turbulence value was obtained.

The processing involves the application to the turbulence value or vector Tp of a transfer function F(k1, k2, k3, . . . kn), where k1, k2, k3, . . . kn are (block 27) the structural parameters of the aircraft, such as the parameters of the fluid surrounding it and the other momentary conditions which influence the Tp, so as to eliminate their influence and thus obtain from the convolution of Tp with the transfer function F(·) a value N₁ which may defined as being a “turbulence factor” (or absolute acceleration) associated with the Tp by the parameters which vary between from aircraft to aircraft.

Essentially, when the device 11 detects a turbulence and detects the acceleration values caused by it, suitably spatially oriented, and represented by the vector Tp, the following formula is applied to Tp:

N=Tp\textcircled{P}F(k1,k2,k3, . . . ,kn)

or also

N=f(Tp,k1,k2,k3, . . . ,kn)

where the value at the correct moment for the specific aircraft in the specific moment is assigned to the values k1, k2, k3, . . . kn.

For example, these parameters which must be used in each case depending on the flight conditions of the aircraft may be advantageously one or more of the following parameters:
a) the instantaneous weight of the aircraft, at the moment in which it is acted on by the train of turbulent movements
b) the Indicated Air Speed (IAS)
c) the True Air Speed (TAS)
d) the flight level (QNE)
e) the flight altitude (QNH)
f) the Standard Air Temperature
g) the position along the longitudinal axis (Attitude)
h) the wing inclination (Bank Angle)
i) the load factor applied to the aircraft independent of the train of turbulent movements
j) the direction of the nose (Heading)
k) the Wing Area
l) the triaxial dimensions of the object including the dimensions of both the vertical and horizontal stabilizers
m) the wing aspect ratio
n) the maximum cross-section of the main body of the object
o) the direction and speed of the train of turbulence acting on the aircraft structure

The structural parameters of the aircraft and the fluid surrounding it, which must be taken into account, may be entered in the memory of the device 11, for example during a set-up step. Some of the parameters may be easily obtained directly via the sensors of the device, such as the flight direction and speed, or may be obtained by means of known calculations based on the information of the device sensors, such as the air density as from a particular height, which may be obtained by the GPS of the device. Other parameters, such as the weight of the aircraft may be obtained by means of direction connection of the device 11, 14 to the aircraft instrumentation or may be estimated from initial data loaded in the memory of the device at the start of the flight. The parameters loaded at the start of the flight (or in any case when the device is placed on-board on the aircraft) are for example the structural data dependent on the aircraft type and model. The data which is updated during the flight by means of an estimate made by the device may for example comprise the aircraft weight. In this case, initially the aircraft weight upon take-off is entered in the device, and then the device itself, using its own internal GPS (or other known system able to trace the horizontal and vertical path followed by the aircraft), may calculate the distance travelled and estimate the fuel consumption so as to update the aircraft weight with a precision which may be sufficient for the purposes of the present invention.

With reference to FIG. 4, in order to determine the turbulence Tp actually perceived by the aircraft it is possible to consider, for practical reasons, only its projection along the vertical axis z of a system of orthogonal coordinates Oxyz having the axis z in the tail-nose direction and the axis y in the direction orthogonal to x passing through the wings, as schematically indicated at the bottom and on the right of FIG. 4, with its origin, coinciding with the centre of mass or gravity (indicated as “c.g.” in the figure).

In this case, the function F is the projection function on the axis z, which has the positive direction oriented downwards.

Considering again FIG. 3, once N has been obtained, it may be sent to the other aircraft, transmitting it wirelessly together with the spatial coordinates of the point P1 where the associated turbulence was detected. These coordinates are advantageously supplied by the GPS of the device (block 28).

The pair of values N1,P1 will be received by the remote station 13 which may thus forward to all the other aircraft present in the system the information (N₁,P₁) or, in the real situation of several aircraft, each of which transmits to the remote station its value Ni-th detected at the turbulent point Pi-th, a group or cloud of values (N1,P1), (N2, P2), . . . , (Ni,Pi). The group of values may also be processed in the form of a map, also with interpolation of values N of points sufficiently close in space to allow calculation of a gradient of N in an area of the space instead of at a precise point P.

For the sake of simplicity, FIG. 3 shows the example of a single pair of values N₂, P₂ received from the combined device 11, 14 which transmits its pair N₁, P₁ and receives a pair N₂, P₂ produced by another device 11.

The device which in an aircraft receives N₂, P₂ (or a map or group of values) may then calculate (block 29) the real values of turbulence Tp₂=Δg₂ which would be perceived on this aircraft if it were also to pass through the point P2 by simply applying the inverse formula:

Tp=N\textcircled{P}F⁻¹(k1,k2,k3, . . . ,kn)

or also

Tp=f⁻¹(N,k1,k2,k3, . . . ,kn)

where k1, k2, k3, . . . kn are again the associated specific parameters of the block 27 and N is the received value associated with the desired point Pi.

The calculated value (or predicted value for the point P₂) may be processed by the processing unit 16 of the device, together with the coordinates of the point P2, and shown in a preferred format (for example both numerically and graphically) on the screen 22.

It is thus possible to obtain, for example, a map of predicted turbulences which is specific for the aircraft, and the pilot may use this in order to take decisions, for example in order to establish the route to be followed and the most advantageous variants.

A schematic representation of the system as a whole is shown by way of example in FIG. 5, which shows a cloud of values N, each with its own spatial position and distributed within an area of the flying space, with the device 11, 14 on each aircraft which may calculate the indicative value for it of the turbulence which would be encountered if one of these turbulence points (or zones) were to be passed through.

FIG. 8 illustrates the possible results of the processing operations on the screen of the device according to the invention. In particular, these results may consist of measured and predicted values of vertical acceleration due to gusts detected or predicted by the system, as well as, in a different manner for each single station, a Fasten Seat Belt warning signal. According to a further aspect of the invention, both in the direct formula and in the inverse formula, the parameters k may also include a number of corrective constants obtained empirically from tests.

The value of these constants may advantageously be refined by means of successive approximations which may consist in calculating N for an aircraft entering turbulence at a point Pi, using this value N to calculate the predicted value of Tp of another aircraft if it were to pass through this point Pi and then allow this aircraft to actually pass through the point Pi, so as to detect the real turbulence Tp with a device 11 which is present on-board this second aircraft and compare it with the predicted Tp, adjusting the constants in the case of any discrepancies.

By repeating this test a sufficient number of times, it is possible to increasingly approximate statistically the real value with the predicted value. This refinement may also be performed using the entire system applied to a sufficiently large number of aircraft in normal flight along the normal air routes and with the normal probability of encountering turbulence, until the system is able to obtain the predictions with the desired degree of precision.

Obviously, the information sent by the system may also be selected so as to refer only to the zones within a certain radius of interest for the receiving aircraft, so as to avoid transmitting to the latter an excessive amount of information which is not really of importance for it. The selection may be made by the aircraft or by the system itself which may direct to the single aircraft of a certain zone the turbulence information of this zone.

The information sent by the moving vehicles (in particular aircraft) may also be advantageously in the form of (or be used for the production of) maps or multimedia weather illustrations which are able to provide the turbulence value (or rather acceleration value) which the single vehicle is expected to encounter when it passes through (flies over) that area and which will be modified on the basis of the parameters which the moving vehicle will have when passing through the zone.

Essentially, advantageously, the values determined on the basis of the effect on each aircraft are redistributed by recalculating the effect on each single aircraft for each single point of the route which must be passed through.

In other words, a plurality of moving vehicles may combine to produce a plurality of pairs of parameters which are then distributed as a general turbulence map, the points of which are recalculated, as described above, by a moving vehicle which receives the map so as to obtain a map of the predicted turbulence affecting it at the points of the general map.

It is thus possible to obtain advantageously a specific map for each aircraft (hitherto the information relating to the atmosphere was only associated with the area flown over and not with the characteristics of the aircraft passing through the flow).

The general maps may also be advantageously calculated by the fixed stations which receive the data from all the moving vehicles and which then distribute them to all the moving vehicles concerned.

The direct and inverse functions used depend essentially on the physical behaviour of the vehicles moving in the specific fluid and at this point may be imagined by the person skilled in the art on the basis of the description provided here

In order to clarify things, a practical calculation example is provided below. For the sake of simplicity, the calculation is carried out for aircraft which differ from each other only in terms of weight and have all other defining parameters which are identical, in order to calculate the effect inside the aircraft of the turbulence of the fluid in which it is moving.

Let us assume therefore that on an aircraft A of weight W_{A}=10000 kg the on-board device 11 detects a Tp representing a vertical acceleration equivalent to 1.5 g (the sign in this case is not regarded as relevant) during a turbulence at a point Pi. The system must calculate, based exclusively on the measurements performed by the aircraft A, the turbulence acceleration which would affect three aircraft B, C, D with a weight, respectively, of W_{B}=20,000 kg, W_{C}=30,000 kg, W_{D}=40,000 kg if they were to pass through the same point Pi. Considering that, for the example given, all the parameters do not vary except for the weight and that therefore they are uninfluential in the transfer function, the following equation may be defined:

N=f(Tp,k1,k2,k3, . . . ,kn)=f(1.5,10,000)

The vertical acceleration produces the effect of a momentary variation in weight, namely the weight of the aircraft A will change during the turbulence from W_{A}=10000 kg to W_{A}_{_{T}}=1.5W_{A}=15,000 kg. It is therefore possible to consider, for the sake of simplicity:

N=1.5W_{A}−W_{A}=W_{A}(1.5−1)=5000

The aircraft B, C, D will therefore receive all the absolute information N=5000 for the point Pi.

The inverse formula Tp=f(N, k1, k2, k3, . . . , kn) is in the simplified case of the example equal to:

Tp=(N/W)+1

with W which represents the weight of the generic receiving aircraft.

The aircraft B will calculate its own turbulence value associated with the point Pi as Tp=(5000/20000)+1=1.25, i.e. a vertical acceleration equal to 1.25 g.

The aircraft C will calculate its own turbulence value associated with the point Pi as Tp=(5000/30,000)+1=1.66, i.e. a vertical acceleration equal to 1.166 g.

The aircraft D will calculate its own turbulence value associated with the point Pi as Tp=(5000/40,000)+1=1.125, i.e. a vertical acceleration equal to 1.125 g.

Obviously, in the case of a variation also of other parameters apart from the weight, in the direct and inverse function there may a series of constants or parameters which are varyingly combined and for example dependent on the fluid and the aircraft (air temperature, height, wing shape, speed, etc.) in accordance with that which may be now imagined by the person skilled in the art.

By way of a further simplified example, let us consider the case of two aircraft A1 and A2 which are identical to each other, with the same weight, but with different speeds.

By way of a calculation example, let us assume that the weight of the two aircraft is equal to 100,000 kg and the indicated air speed (IAS) is 300 km/h for the first aircraft and 350 km/h for the second aircraft.

Below the following symbols are used:

t′=the instant in which A1 passes through the turbulent flow which produces in it an increase in the load factor (acceleration) measured by the system according to the invention.
t″=the instant in which A2 passes through the turbulent flow which it is assumed is situated at the same point and with the same physical characteristics as those encountered at the instant t′ by A1.

Let us assume that the increase in acceleration (increase in load factor) affecting A1 in the turbulence detected at the instant t′ is measured by means of the on-board device 11, equivalent to Δ=1.15 g.

It is therefore desired to determine, by means of the invention, the acceleration which will affect A2 as a result of the same turbulent flow passed through at t′ by A1.

FIG. 6 shows the graph, known in aerospace technology, representing the gust diagram for the aircraft concerned.

The speed in km/h (in the specific case) is shown along the x axis and the load factor (n) (also called acceleration in g) is shown along the y axis. It can be noted that the lines departing from the y axis intersect this axis where the load factor=1, since they are calibrated for activity on the planet earth where the basic gravitational acceleration is equal to 1 g.

Each line of the gust diagram represents a value of the vertical component (positive, if ascending, or negative if descending) of the gust. This vertical component represents the cause, in aeronautical terms, of the acceleration affecting the aircraft and commonly referred to as “turbulence”.

The increase in speed parallel to the direction of movement is not considered in the example since it is not relevant for fixed-wing aircraft. Instead, the increase in lift which is generated by the artificial increase in angle of attack (a) produced by the vertical component is much more important. This increase in the angle of attack causes a sudden increase in lift (L) which results in an instantaneous increase in the load factor (accelerator) which is that readily measured and recorded by the device 11 according to the invention.

For example, in the case of an undisturbed state without an increase in the acceleration from the basic acceleration equal to 1 g, the half-line departing from the point of value n=1 remains parallel to the x axis and therefore in this condition there is a vertical wind=0 and therefore the device 11 will provide an incremental value of acceleration equal to 0.

Therefore it is possible to determine the value of the vertical component of the gust based on the acceleration n detected by the sensor of the device 11 and the speed in km/h.

For this calculation reference may be made to the gust diagram shown in FIG. 7 which shows the horizontal line (broken line) corresponding to Δ=1.15 g and the vertical lines corresponding to the two speeds 300 km/h and 350 km/h.

The inclined line which passes through the y axis at the point equal to 1 and at the speed intersection point 300 and Δ=1.15 g represents the effect of the ascending vertical gust (7.6 m/s).

The intersection of this inclined line with the vertical speed line of A2=350 km/h corresponds on the y axis to the vertical acceleration Δ2 which will affect the aircraft with a speed of 350 km/h and acted on by the same gust as the first aircraft. The calculation of this value may be simply performed by means of trigonometry, as may be now easily imagined by the person skilled in the art.

Obviously, once the acceleration effect has been detected, the various influences arising from the different configurations which affect the different measurement of the acceleration affecting the aircraft in flight will be composed in algebraic terms. This will result in the definition of the functions f( ) and f⁻¹( ) as described above, with any corrective parameters k, also detected experimentally, if desired.

At this point it is clear how the invention may be applied.

According to further aspects of the invention, the devices 11, 14 according to the invention may also advantageously provide further useful functions owing to their capacity to detect or predict the turbulence encountered by an aircraft.

In particular it has been found to be particularly advantageous for the devices to be able to provide automatically instructions for implementing a given procedure in view of possible turbulence or during the course of turbulence.

For example, in the case of an intense action of the turbulent flow the pilots must normally implement procedures which are contained in a special check list. This check list may be in paper form, placed inside special containers, or in electronic form, and the pilot must retrieve said list and display it on a monitor in the flight cabin. Apart from the delay in the application of the procedures, this means that, in the event of particularly violent turbulence, the pilot may be unable to recover rapidly the check list.

By storing instead the check list in the memory 18 of the device according to the invention located in the cabin and programming the device to show this check list when the turbulence value detected or predicted or greater than a certain predefined value, it is possible to ensure that the check list is immediately available when needed.

In other words, with the solution according to the invention it is possible to activate procedures in electronic form without the need for action on the part of the pilot, but on the basis of the accelerations affecting the device according to the invention. When a turbulence with a value such as to require a certain procedure is detected or predicted by the device, the procedure (i.e. the check list) appears automatically on the display of the device so that the pilot may immediately carry it out or get ready to carry it out.

Moreover, since one of the more negative effects of the turbulence may be the near-impossibility of reading screens or sheets owing to the excessive vibration of the aircraft, speech synthesis facilities incorporated in the device may be used so that the device is able to provide verbal instructions when the turbulence is at a level such that the pilot is unable to see clearly but only understand oral commands.

Such a solution is particularly advantageous when the entire device or at least the display [art thereof is integrated or interfaced with the on-board instrumentation in the flight cabin. For example, this solution may be applicable to aircraft (e.g. AirBus350/Boeing 787 Dreamliner) which are equipped with Class 3 viewing systems, i.e. which are interfaced directly with the pilot by means of touchscreen displays (similar to tablets). Therefore the solution is applicable to a suitable client connected to the inertial sensors duly calibrated for the predicted turbulence value, as in the aforementioned description.

A further automated procedure may be the appearance and activation of the Fasten Seat Belt command following a predetermined turbulence value detected or predicted by the device according to the invention.

In fact, the pilot who is passing through turbulence must, to ensure the safety of the passengers, activate the Fasten Seat Belt signals. He, however, may forget to do so or may underestimate the intensity of the turbulence accelerations.

Thanks to the principles of the present invention, the device which detects or predicts the turbulence may activate a call to the pilot in order to remind him to activate the warnings or may be directly connected to the on-board system for automatic activation of the warnings. Moreover, owing to the turbulence prediction from the other aircraft in the interconnected version described above, the prediction of future turbulence calculated on the basis of the typical data of each aircraft may also allow activation in advance of the Fasten Seat Belt signal in accordance with a turbulence value set in the device as threshold for this activation, thus avoiding the problems caused by untimely alerting of the passengers.

Obviously, the aforementioned functions may be provided in the device which detects the turbulence also independently of the possibility of receiving turbulence data from a remote station. For example, the device may also not be connected to a network for distribution of the information relating to turbulence zones or points, if it is not desired or required to obtain a predictive function from the device in order to signal operations to be carried out before entry into the turbulence, but only signalling of the degree of turbulence and initiation of a specific procedure in the event of detection by the device of a turbulence acting in that moment on the aircraft.

At this point it is clear how the predefined objects have been achieved by providing a method and a system for the objective measurement of the mechanical energy, produced by a train of turbulent movements, perceived by a moving vehicle located in a fluid within a predetermined time interval and for the calculation of the presumed measurement of the mechanical energy which would be perceived as result of that same sequence of turbulent movements by another moving vehicle having usually different geometric, dynamic and/or mechanical characteristics. As is now clear, the uses of this method and system may be multiple both in the aeronautical sector and in the naval sector.

Obviously the description above of an embodiment applying the innovative principles of the present invention is provided by way of example of these innovative principles and must therefore not be regarded as limiting the scope of the rights claimed herein. For example, for the sake of simplicity, data, functions and results of the processing operations have often been indicated above in relation to numerical values, but it is understood that all the operations may envisage the use of vectors and vector operations, as may be easily imagined by the person skilled in the art. The acceleration and/or position detection sensors may also be devices external to the portable device (for example a suitably programmed tablet) and connected to it via a cable or wireless connection or may be engaged directly with a connector of the portable device.

For example, the functions of the integrated electronic device 11, 14 described above may be separate in an external unit provided with the sensors for the system according to the invention (for example triaxial accelerometers and laser gyroscopes), as described further above, and a portable display (and processing) device, both present on-board the same moving vehicle. This external unit (which essentially forms the aforementioned electronic detection device) may also comprise other sensors (normally not inserted in a tablet/smartphone) useful for combining the inertia measurements with other elements and/or one or more GPS receivers and/or other position detection systems.

The external unit is then interfaced with the portable device (for example a tablet or a suitably programmed smartphone) so as to send the data to it and allow displaying of the results as already described above. Communication between the external unit and the portable device may occur in wireless mode or by cable.

Transmission to the earth system may be performed by the external unit, directly or via further communication of the said unit with a suitable transmission system (not shown) present in the same moving vehicle, as may now be easily imagined by the person skilled in the art on the basis of the above description.

The external unit may be realized, for example, with a microprocessor unit, known per se, suitably programmed to carry out processing of the parameters detected by the sensors before they are sent to the portable device, so as to send to the portable device data which is already processed, this relieving the portable device of the corresponding processing function. Advantageously, the external unit may also be provided with its own suitable memory able to store the data for subsequent analysis or for local processing.

Processing may also be divided up, being performed partly in the external unit (for example for pre-processing and rough-processing of the data detected by the sensors) and partly in the portable device.

By assigning all or part of the data processing to the external unit it is possible to obtain a portable device which may be, for example, less powerful or therefore less costly.

The external unit may also send data to several portable devices on-board the same vehicle. The external unit may be incorporated in the aircraft instrumentation or, preferably, be an independent device, for example provided with a mounting system (e.g. Velcro, adhesive fasteners, special mechanical mounts fitted to the structure) so that it can be removably fixed, for example, to the cockpit structure of the aircraft, so as to be rigidly connected to the structure and adequately detect the stresses resulting from the turbulence. The external unit may also be provided with its own rechargeable battery and/or with a display able to provide feedback on its own operating condition without having always to connect to or communicate with the portable device.

Obviously, the physical dimensions of the external unit may vary depending on the circumstances and the equipment used, but it is preferably a portable system and therefore is movable and easy to transport.

During operation of the system, once the external unit has been mounted on the moving vehicle which will be subject to turbulence, and is connected to the portable device (or to the portable devices) on the same moving vehicle, it transfers (preferably in real time, but also with a time delay), to the portable device the measurements performed by the sensors and/or the data to be displayed.

The ways of using the data detected by the sensors in order to realize the system according to the invention may be of a varied nature.

For example, in the case where the portable device has sensors designed to detect the effects of the turbulence (thereby also forming with it a fully integrated electronic device 11, 14, as described above), both the measurements performed by the sensors of the external unit and the measurements performed by the sensors of the portable device may be used.

Advantageously, in this case, the total measurement may be determined as an average value of two measurements. Alternatively, it may be envisaged that the two measurements are not averaged and that the portable device may use, automatically or manually (for example following a user command), either measurement depending on a series of data supplied by other sensors or on the basis of system requirements or the like, in order to determine which measurement is to be regarded as valid and reliable.

In the case where the portable device does not have sensors or for some reason it is not desired to use the sensors of the portable device (for example because they are considered to be at least momentarily unreliable), the measurements to be processed in accordance with the system of the invention are only those of the sensors in the external unit.

Owing to the use of an external unit as described above, problems of false readings due for example to movement of the portable device caused by the user during its use—and not by turbulence conditions—are avoided.

In particular, for example it has been noted that in some cases the use of a portable device with a touchscreen may result in measurement errors due to light tapping of the screen by the user during use. The interaction between use and screen results, in fact, in an erroneous reading of the values detected by the accelerometers inside the portable device, which are therefore disturbed during measurement owing to the acceleration created by the impact of the fingertip on the screen and, if this occurs during a period where the aircraft is passing through turbulence, the value is falsified and consequently the measurement is inaccurate or void. This problem is completely avoided by using the external unit described above.

1. Method for processing and providing information relating to the effects of turbulent movements present in a fluid and perceived or perceivable by a moving vehicle when acted on by these turbulent movements, comprising the steps of:
detecting on-board a first moving vehicle A a perceived level of turbulence Tp_{A} to which the vehicle is subject in that moment;
calculating a parameter N indicative of the turbulence by applying to the perceived level of turbulence Tp_{A} a correction function f(Tp_{A}, k1_{A}, k2_{A}, k3_{A}, . . . , kn_{A}) where k1_{A}, k2_{A}, k3_{A}, . . . , kn_{A} are parameters considered to be indicative of the influence of the specific first moving vehicle A on the level of turbulence perceived in it;
transmitting a pair of values formed by the parameter N and the position P of the first moving vehicle A in the moment when it is subject to the level of turbulence Tp_{A}, so that they are received by a second moving vehicle B;
calculating on-board the second moving vehicle B a predicted level of turbulence Tp_{B} by means of an inverse function f⁻¹(N, k1_{B}, k2_{B}, k3_{B}, . . . , kn_{B}), where k1_{B}, k2_{B}, k3_{B}, . . . , kn_{B} are parameters considered indicative of the influence of the specific second moving vehicle B on the level of turbulence perceivable therein based on the parameter N;
using the predicted level of turbulence Tp_{B} as an indication of the level of turbulence which would be perceived on the second moving vehicle B if it were to pass through the said point P.

2. Method according to claim 1, wherein the first moving vehicles A consist of a plurality so as to provide a corresponding plurality of pairs of values N, P which define a map, in the fluid, of parameters N associated with the positions P of the moving vehicles of the plurality.

3. Method according to claim 1, wherein the transmission of the pair of values N,P from the first to the second moving vehicle is performed by means of at least one remote station.

4. Method according to claim 1, wherein the at least one remote station is an earth station or satellite station.

5. Method according to claim 1, wherein the moving vehicles are aircraft.

6. Method according to claim 1, wherein, in order to detect on-board the first moving vehicle A, the perceived level of turbulence Tp_{A}, accelerations which have been entered in an electronic detection device and are considered to be indicative of the perceived level of turbulence Tp_{A}, are detected and processed.

7. Method according to claim 1, wherein several first moving vehicles cooperate to produce a plurality of parameter pairs which are distributed as a general turbulence map, the points of which are recalculated by a said second moving vehicle in the form of a map of the predicted turbulence affecting it at the points of general map.

8. A system (10) for processing and supplying information regarding the effects of turbulent movements present in a fluid and perceived or perceivable by a moving vehicle when acted on by these turbulent movements, the system using the method according to any one of the preceding claims and being characterized in that it comprises an electronic detection device (11) located on the first moving vehicle A and comprising acceleration sensors (19) for detecting a perceived level of turbulence Tp_{A}, a processing unit (16) intended to calculate the parameter N, an electronic memory (18) intended to contain the parameters k1_{A}, k2_{A}, k3_{A}, . . . , kn_{A}, a GPS receiver (21) intended to detect the position P, and a transmitter (17) for communicating remotely the pair of values N, P.

9. The system according to claim 8, characterized in that it comprises an electronic signalling device (14) located on the second moving vehicle B for receiving the pair of values N, P, calculating the predicted level of turbulence Tp_{B} and displaying it.

10. The system according to claims 8 and 9, characterized in that it comprises integrated electronic devices (11,14) which comprise both an electronic detection device (11) and an electronic signalling device (14) and which are intended to be located on-board both the first moving vehicle A and the second moving vehicle B.

11. The system according to claim 10, characterized in that the integrated electronic devices are programmed tablets.

12. The system according to claims 8 and 9, characterized in that it comprises at least one remote station for communication between the electronic detection device located on the first moving vehicle and the electronic signalling device located on the second moving vehicle.

13. The system according to claim 10, characterized in that the integrated electronic device comprises instructions stored in it for implementing a predetermined procedure upon detection of a perceived turbulence value or upon calculation of predicted turbulence level higher than a predetermined threshold level.

14. The system according to claim 13, characterized in that the procedure comprises the displaying of a check list.

15. The system according to claim 13, characterized in that the procedure comprises the displaying of a Fasten Seat Belt signal for passengers present on the moving vehicle.

16. The system according to claim 12, characterized in that the remote station receives the parameters from electronic detection devices on a plurality of first moving vehicles and distributes these parameters in the form of a general turbulence map, the points of which are recalculated by the electronic signalling device on said second moving vehicle as a map of the predicted turbulence affecting it at the points of the general turbulence map.
